(19) United States
(12) Patent Application Publication
(10) Pub. No.: US 2008/0278467 A1
(43) Pub. Date: Nov. 13, 2008

(54) LIQUID CRYSTAL DISPLAY HAVING PROGRESSIVE AND INTERLACED MODES, AND DRIVING METHOD OF THE LIQUID CRYSTAL DISPLAY

(76) Inventors: In-jae Hwang, Cheonan-si (KR); Sang-moon Mo, Cheonan-si (KR)

Correspondence Address: Frank Chau, Esq.;F. CHAU & ASSOCIATES, LLC, 130 Woodbury Road, Woodbury, NY, 11797, US

(21) Appl. No.: 12/021,045

(22) Filed: Jan. 28, 2008

(30) Foreign Application Priority Data
May 9, 2007 (KR) 10-2007-0045192

(51) Int. Cl. G09G 5/00; G09G 3/36

(52) U.S. Cl. 345/205; 345/87; 345/92

(57) ABSTRACT

A liquid crystal display (LCD) having a progressive mode and an interlaced mode and a driving method of the LCD are provided. The timing controller of the LCD includes a (progressive/interlaced) mode selector and a signal generator. The mode selector receives display mode information from an external circuit and outputs a mode signal selecting a progressive mode or an interlaced mode. The signal generator selectively outputs first and second scan start signals to odd and even gate line drivers, in response to the mode signal, the first and second scan start signals having a phase difference equal to one horizontal period. In the progressive mode, the signal generator outputs both a first scan start signal and a second scan start signal during the time period of one frame. In the interlaced mode the signal generator outputs the first scan start signal during the time period of one frame and then outputs the second scan start signal during the time period of the next one frame.

### CROSS-REFERENCE TO RELATED APPLICATION

This application claims priority, under 35 USC §119, of Korean Patent Application No. 10-2007-0045192 filed on May 9, 2007, in the Korean Intellectual Property Office, which is incorporated herein by reference in its entirety.

### BACKGROUND OF THE INVENTION

1. Field of the Invention

The present invention relates to liquid crystal displays, and more particularly relates to a liquid crystal display comprising a timing controller adapted to alternately support a progressive mode and an interlaced mode, and a driving method of the liquid crystal display.

2. Description of the Related Art

In a liquid crystal display (LCD), a gate driver integrated circuit (IC) has conventionally been mounted onto the glass display panel substrate using various structures, for example, tape carrier package (TCP), chip on glass (COG), and the like. Presently, however, another approach is being attempted: A gate driver integrated circuit (IC) is formed directly on a glass substrate using an amorphous silicon (a-Si) thin film transistor (referred to as “a-Si TFT” hereinafter), instead of using a pre-packaged gate driver IC.

Also, currently a conventional LCD operates in only a predetermined one of a progressive mode or an interlaced mode. Progressive mode means that the screen refreshes all lines on the screen simultaneously (one after the other) every frame. Interlaced mode means that the screen refreshes half the lines on the screen every frame (every other line). In the interlaced mode the screen sequentially refreshes all the odd lines first and then sequentially refreshes all the even lines.

### SUMMARY OF THE INVENTION

An aspect of the present invention provides a display device capable of operating alternately in both a progressive mode and an interlaced mode. An aspect of the present invention provides an LCD that operates having reduced power consumption and/or improved display quality.

Another aspect of the present invention also provides a liquid crystal display (LCD) capable of operating alternately in both a progressive mode and an interlaced mode.

Another aspect of the present invention provides a method of driving a liquid crystal display (LCD) capable of operating alternately in both a progressive mode and an interlaced mode.

According to an aspect of the present invention, there is provided a liquid crystal display (LCD) including a signal-supply unit configured to receive display mode information for selecting between a progressive mode and an interlaced mode and to selectively supply a first scan start signal and a second scan start signal to odd and even gate line drivers based upon the selected mode, the first and second scan start signals having phases different from each other. The liquid crystal display (LCD) panel includes a plurality of gate lines, a plurality of data lines, and a plurality of pixels coupled to the gate lines and data lines, the a plurality of gate lines divided into first and second gate line groups, a first gate driver configured to sequentially output first gate signals to the first gate line group in response to the first scan start signal and, and a second gate driver configured to sequentially output second gate signals to the second gate line group in response to the second scan start signal. While in a progressive mode, the signal-supply unit supplies the first scan start signal to the first gate driver and the second scan start signal to the second gate driver during the time period of one frame. While in the interlaced mode, the signal-supply unit supplies the first scan start signal to the first gate driver during the time period of one frame and then supplies the second scan start signal to the second gate driver during the time period of the next one frame.

According to another aspect of the present invention, there is provided a liquid crystal display (LCD) including a timing controller configured to receive display mode information that selects a progressive mode or an interlaced mode to selectively supply a first scan start signal and a second scan start signal to a first (e.g., odd) gate driver and a second (e.g., even) gate driver respectively, the first and second scan start signals having phases different from each other. While in a progressive mode, the timing controller supplies the first scan start signal and the second scan start signal during the time period of one frame. While in the interlaced mode, the timing controller supplies the first scan start signal to the first gate driver during the time period of one frame and then supplies the second scan start signal to the second gate driver during the time period of the next one frame.

The liquid crystal display (LCD) may further comprise a clock generator for selectively generating, based upon the mode, a first clock signal and an inverted first clock signal having a phases opposite to that of the first clock signal using a first clock generation control signal, and a second clock signal and an inverted second clock signal having a phases opposite to that of the second clock signal using a second clock generation control signal, the first clock signal and the second clock signal having different phases. The timing controller may also selectively supply the first clock generation control signal and the second clock generation control signal to the clock generator, the first and second clock generation control signals having phases different from each other.

The liquid crystal display (LCD) may further comprise an LCD panel including a plurality of gate lines, a plurality of data lines, and a plurality of pixels coupled to the gate lines and data lines, the a plurality of gate lines divided into first and second gate line groups, the first gate driver configured to sequentially output first gate signals to the first gate line group in response to the first scan start signal, and the second gate driver configured to sequentially output second gate signals to the second gate line group in response to the second scan start signal.

According to still another aspect of the present invention, there is provided a display device including a timing controller, comprising: a mode selector configured to receive display mode information from an external circuit and outputting a mode signal selecting a progressive mode or an interlaced mode; and a signal generator configured to selectively output, based upon the mode signal, a first scan start signal and a second scan start signal, the first and second scan start signals having different phases. While in the progressive mode the signal generator outputs the first scan start signal and the second scan start signal during the time period of one frame. While in the interlaced mode, the signal generator outputs the first scan start signal during the time period of one frame and then outputs the second scan start signal during the time period of the next one frame.

According to a further aspect of the present invention, there is provided a method of driving a liquid crystal display (LCD), the method including receiving display mode information, and based on the received display mode information, operating in either a progressive mode or an interlaced mode. While in the progressive mode, supplying a first scan start signal and a second scan start signal and sequentially supplying gate signals to a plurality of odd and even gate lines in response to the first and second scan start signals during the time period of one frame. While in the interlaced mode, supplying the first scan start signal and sequentially supplying gate signals to the plurality of odd gate lines in response to the first scan start signal during the time period of one frame, and then supplying the second scan start signal and sequentially supplying gate signals to the plurality of even gate lines in response to the second scan start signal during the time period of the next one frame.

The features of the present invention may be understood more readily by persons skilled in the art by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

### BRIEF DESCRIPTION OF THE DRAWINGS

The above and other features of the present invention will become apparent to persons skilled in the art by describing in detail preferred embodiments thereof with reference to the attached drawings in which:

FIG. 1 is a block diagram of a liquid crystal display (LCD) including a timing controller 500 according to an exemplary embodiment of the present invention;

FIG. 2 is an equivalent circuit diagram of one pixel of the LCD of FIG. 1;

FIG. 3 is a block diagram of the timing controller 500 shown in FIG. 1;

FIG. 4 is a signal diagram for explaining operations of a signal-supply unit and first and second gate drivers in the timing controller 500 of the LCD of FIG. 1, in a progressive mode;

FIGS. 5A and 5B are signal diagrams for explaining operations of a signal-supply unit and first and second gate drivers in the timing controller 500 of the LCD of FIG. 1, in an interlaced mode;

FIG. 6 is a block diagram of the clock generator 600 shown in FIG. 1;

FIG. 7 is a signal diagram for explaining the operation of the clock generator 600 shown in FIG. 6;

FIG. 8 is a block diagram of the first gate driver 401 in the LCD of FIG. 1; and

FIG. 9 is a circuit diagram of stages in the first gate driver shown in FIG. 8.

### DETAILED DESCRIPTION OF EXEMPLARY EMBODIMENTS OF THE INVENTION

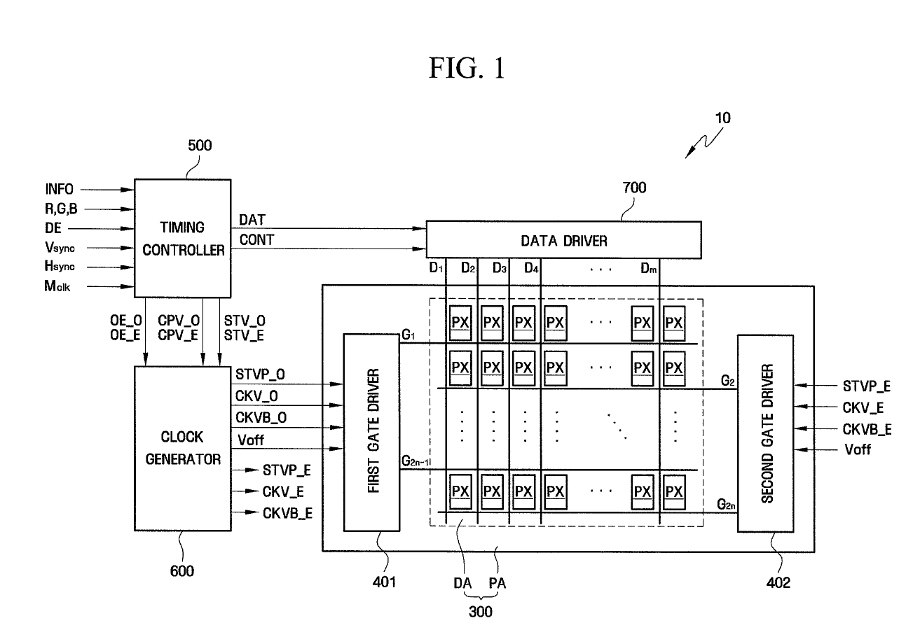

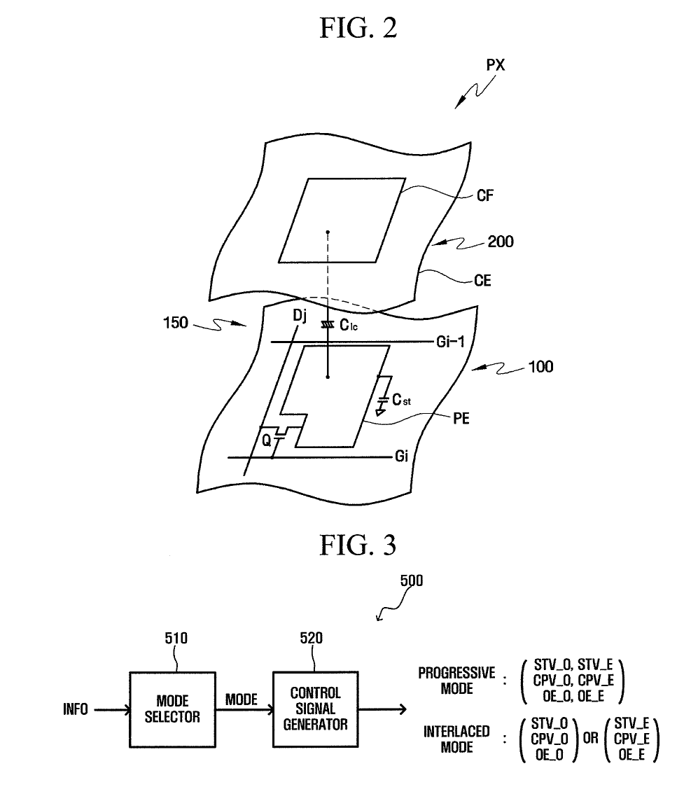

A liquid crystal display (LCD) including a timing controller adapted to alternately support a progressive mode and an interlaced mode, and a method of driving the LCD will be described with reference to FIGS. 1 and 2.

FIG. 1 is a block diagram of a liquid crystal display (LCD) including a timing controller, according to an exemplary embodiment of the present invention, and FIG. 2 is an equivalent circuit diagram of one pixel of the LCD of FIG. 1. In the following description, STVP_O and STVP_E are signals that are produced by amplifying voltage levels of STV_O and STV_E, respectively, and still perform the same function as the original signals STV_O and STV_E. STVP_O and STV_O are referred to as first scan start signals and STVP_E and STV_E are referred to as second scan start signals throughout the description of the present invention.

Referring first to FIG. 1, the LCD 10 according to an exemplary embodiment of the present invention includes an LCD panel 300, a signal-supply unit, a first gate driver 401, a second gate driver 402, and a data driver 700. The signal-supply unit includes a timing controller 500 and a clock generator 600.

The LCD panel 300 includes a display area “DA” where an image is displayed, and a peripheral area “PA” corresponding to a non-display area where an image is not displayed.

The LCD panel 300 within the display area DA includes a first panel (see FIG. 2), a second panel (see FIG. 2), and a liquid crystal layer (see FIG. 2) interposed between the first and second panels, thereby displaying an image. The first panel includes a plurality of gate lines G₁ through Gₙ, a plurality of data lines D₁ through Dₘ, and at each intersection of the gate lines and the data lines, there is a pixel. Each pixel contains a switching element (e.g. TFT, shown in FIG. 2), and a pixel electrode (shown in FIG. 2). The second panel includes a color filter (not shown) and a common electrode (not shown). The plurality of gate lines G₁ through Gₙ extend in a row direction and parallel or essentially parallel to one another, and the plurality of data lines D₁ through Dₘ extend in a column direction and are parallel or essentially parallel to one another.

Each pixel, for example, the pixel PX shown in FIG. 1, will be described in greater detail with reference to FIG. 2. Referring to FIG. 2, each pixel PX includes a color filter CF in a region of the first panel 100 corresponding to a pixel electrode PE. For example, the pixel PX connected to the i-th gate line Gᵢ (where i=1 . . . n) and the j-th data line Dⱼ (where j=1 . . . m), includes a switching element Q that is connected to the signal lines Gᵢ and Dⱼ and a to a liquid crystal capacitor Clc and a storage capacitor Cst. The storage capacitor Cst may be omitted, if unnecessary. The switching element Q may be an amorphous silicon thin film transistor (referred to as “a-Si TFT” hereinafter).

The peripheral area (PA), which surrounds the display area (DA), is not used to display images, and the first panel (100 of FIG. 2) is wider than the second panel (200 of FIG. 2).

The signal-supply unit is supplied, by an external graphic controller (not shown), with input image signals R, G and B and input control signals controlling the display of the input image signals R, G and B. The signal-supply unit supplies the data driver 700 with a data signal DAT and a data control signal CONT. The timing controller 500 receives the input control signals, including a horizontal synchronization signal Hsync, a main clock Mclk, a data enable signal DE, and others, and outputs the data control signal CONT. The data control signal CONT includes a horizontal synchronization start signal for starting the operation of the data driver 700, a load signal for causing the output of two data voltage signals, and so on.

Accordingly, the data driver 700 receives the image signal DAT and the data control signal CONT from the signal-supply unit and supplies the data lines D₁ through Dₘ with image data voltages corresponding to the image data R, G and B. The data driver 700 may be connected to the liquid crystal panel assembly 300 in the form of a TCP (tape carrier package). However, the manner of connecting the data driver 700 and the liquid crystal panel assembly 300 is not limited to the illustrated example, and the data driver 700 may be attached to the liquid crystal panel assembly 300 within the PA.

The signal-supply unit receives a vertical synchronization signal Vsinc, a main clock signal Mclk and display mode information INFO. Responsive to the display mode information INFO, in a progressive mode, during the time period of one frame, the signal-supply unit supplies the first gate driver 401 and the second gate driver 402 with a first scan start signal STVP_O and a second scan start signal STVP_E, respectively. In an interlaced mode, during the time period of one frame, the signal-supply unit supplies the first or second gate driver 401 or 402 with either the first scan start signal STVP_O or the second scan start signal STVP_E.

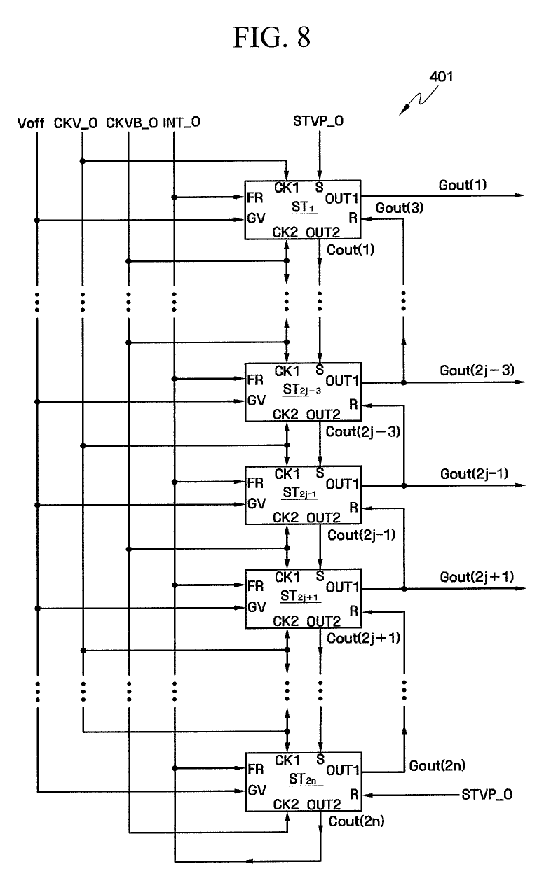

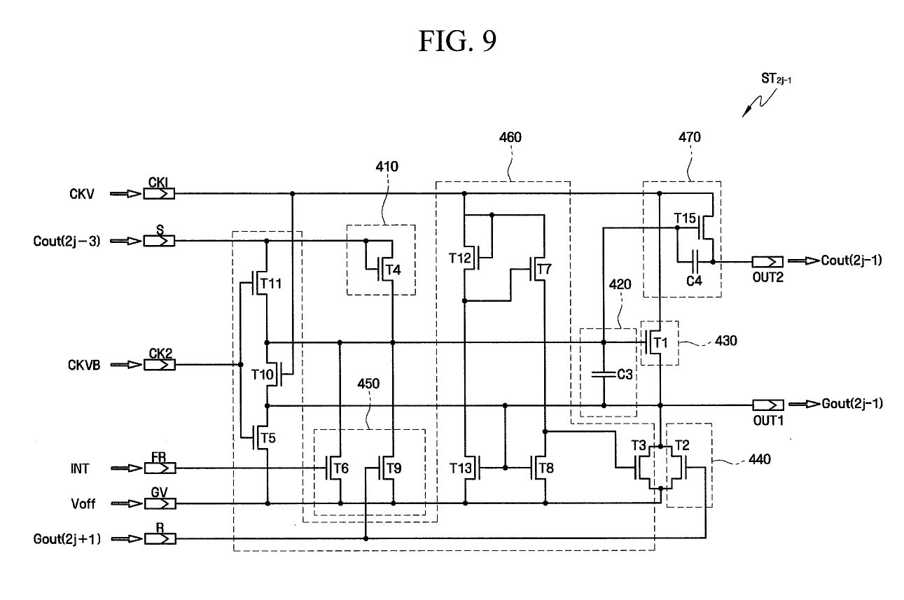

The first gate driver 401 is connected to odd-numbered gate lines G₁-G₂ₙ₋₁ among the gate lines G₁-G₂ₙ, and the second gate driver 402 is connected to even-numbered gate lines G₂-G₂ₙ. Accordingly, in the progressive mode, the first and second gate driver 401 and 402 are both enabled for each frame to apply gate signals to all the gate lines G₁-G₂ₙ. In the interlaced mode, only one of the first and second gate driver 401 and 402 is enabled at a time (enabled alternately) to apply gate signals to corresponding odd or even gate lines among G₁-G₂ₙ. Accordingly, in the progressive mode, the first gate driver 401 supplies the odd-numbered gate lines G₁-G₂ₙ₋₁ with gate signals at each frame, and the second gate driver 402 supplies the even-numbered gate lines G₂-G₂ₙ with gate signals at each frame. In the interlaced mode, the first gate driver 401 is enabled only at odd-numbered frames to supply the odd-numbered gate lines G₁-G₂ₙ₋₁ with gate signals and the second gate driver 402 is enabled only at even-numbered frames to supply the even-numbered gate lines G₂-G₂ₙ with gate signals. Each of the first and second gate drivers 401 and 402 includes a plurality of cascade-connected stages each stage having an amorphous silicon (a-Si) thin film transistor (TFT) formed on the LCD panel 300 to output each gate signal. The first and second gate driver 401 and 402 will be described in greater detail below with reference to FIGS. 8 and 9.

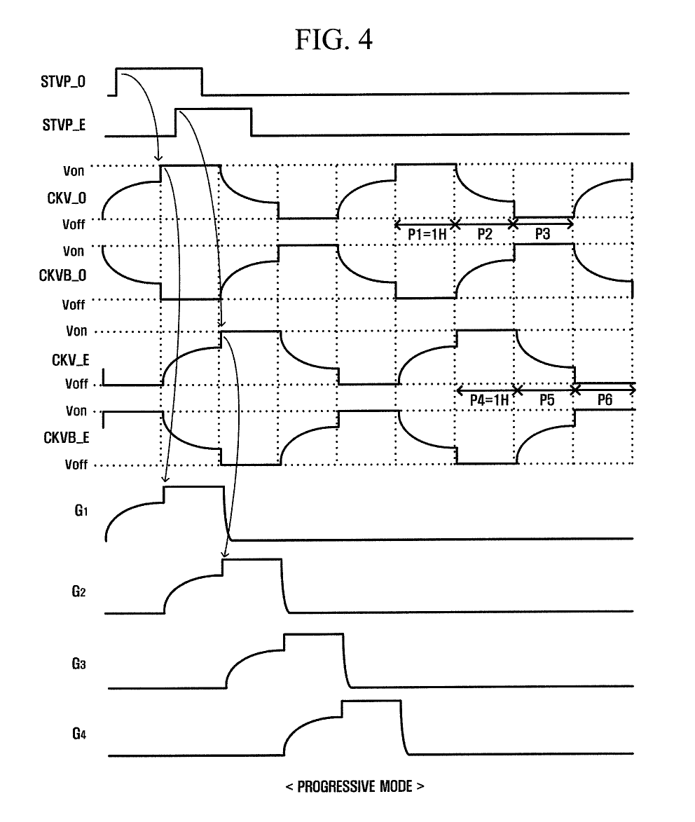

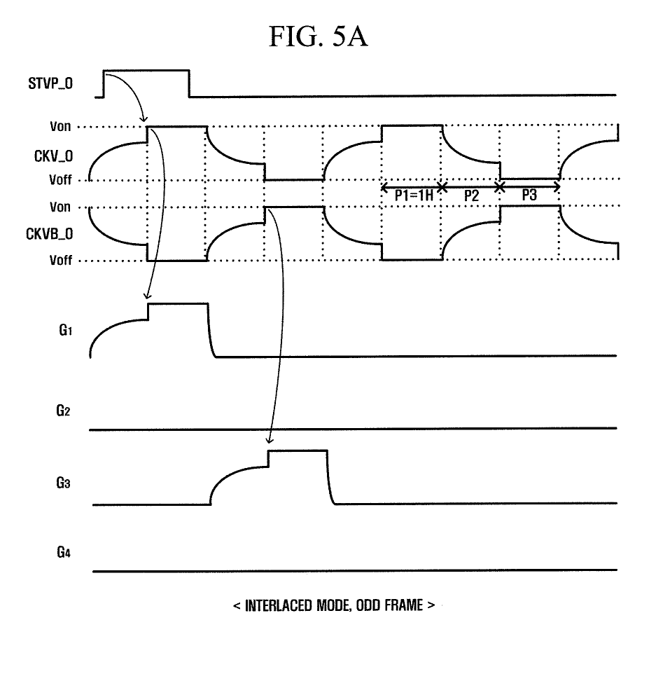

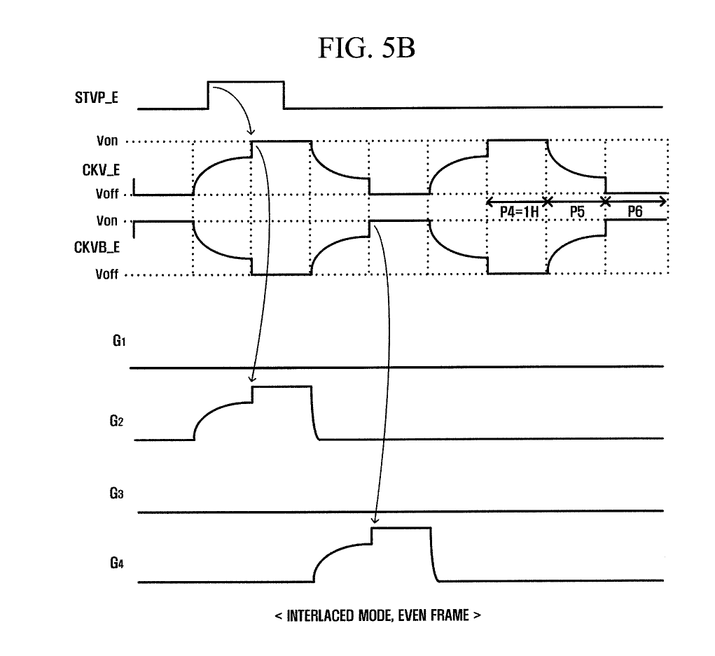

The operations of various modules of the timing controller shown in FIG. 1, in the progressive and interlaced modes, are described in greater detail in the following. FIG. 3 is a block diagram of the timing controller in the LCD of FIG. 1, FIG. 4 is a signal diagram for explaining operations of a signal-supply unit and first and second gate drivers in the LCD of FIG. 1 in a progressive mode, and FIGS. 5A and 5B are signal diagrams for explaining operations of a signal-supply unit and first and second gate drivers in the LCD of FIG. 1 in an interlaced mode.

First, the operations of various modules in a progressive mode will be described in greater detail with reference to FIGS. 1, 3 and 4.

The timing controller 500 includes a mode selector 510 and a control signal generator 520.

The mode selector 510 receives the display mode information INFO from an external circuit and outputs a mode signal MODE for selecting a progressive mode or an interlaced mode. For example, in high-performance display applications such as the game or movie industry, where high display performance is required even at the cost of a large amount of power consumption, the mode selector 510 outputs the mode signal MODE for selecting the progressive mode.

The control signal generator 520 generates a first scan start signal STV_O, a second scan start signal STV_E, a first CPV signal CPV_O, a second CPV signal CPV_E, a first output enable signal OE_O and a second output enable signal OE_E at each frame in response to the mode signal MODE selecting the progressive mode.

The first scan start signal STV_O and the second scan start signal STV_E are signals for instructing the start of operations of the first and second gate drivers 401 and 402 respectively. A pair of the first CPV signals CPV_O and the first OE signal OE_O, and another pair of the second CPV signals CPV_E and the second OE signal OE_E are clock generation control signals for controlling the generation of a pair of the first clock signal CKV_O and the inverted first clock signal CKVB_O and another pair of the second clock signal CKV_E and the inverted second clock signal CKVB_E, respectively. The first scan start signal STV_O and the second scan start signal STV_E may have a predetermined phase difference. In addition, the first CPV signal CPV_O and the second CPV signal CPV_E may have a predetermined phase difference. The first OE signal OE_O and the second OE signal OE_E may also have a predetermined phase difference. Both a pair of the first CPV signal CPV_O and the first OE signal OE_O, and another pair of the second CPV signal CPV_E and the second OE signal OE_E can be used to generate the pair of the first clock signal CKV_O and the inverted first clock signal CKVB_O and the pair of the second clock signal CKV_E and the inverted second clock signal CKVB_E. Alternatively, the first CPV signal CPV_O and the second CPV signal CPV_E can be used to generate the pair of the first clock signal CKV_O and the inverted first clock signal CKVB_O and the pair of the second clock signal CKV_E and the inverted second clock signal CKVB_E.

The exemplary embodiment of the invention will be explained with reference to a case where both the pair of the first CPV signal CPV_O and the first OE signal OE_O and the pair of the second CPV signal CPV_E and the second OE signal OE_E are used, but the invention is not limited to this.

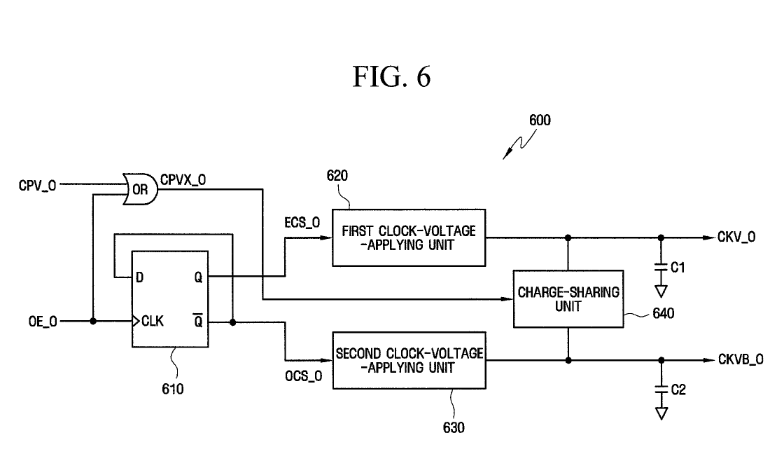

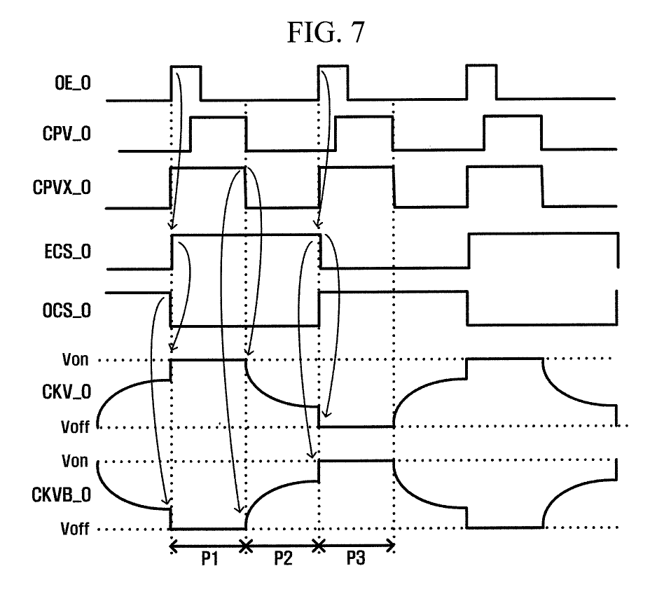

In the progressive mode, the clock generator 600 generates the first clock signal CKV_O, the inverted first clock signal (first clock bar signal) CKVB_O, the second clock signal CKV_E and the inverted second clock signal (second clock bar signal) CKVB_E using the first CPV signal CPV_O, the second CPV signal CPV_E, the first OE signal OE_O and the second OE signal OE_E. In the progressive mode, the clock generator 600 also supplies the first gate driver 401 with a pair of the first clock signal CKV_O and the inverted (bar) first clock signal CKVB_O, and supplies the second gate driver 402 with a pair of the second clock signal CKV_E and the inverted (bar) second clock signal CKVB_E. Here, the first clock bar signal CKVB_O and the second clock bar signal CKVB_E have phases opposite to those of the first clock signal CKV_O and the second clock signal CKV_E, respectively. In addition, a pair of the first clock signal CKV_O and the first clock bar signal CKVB_O and another pair of the second clock signal CKV_E and the second clock bar signal CKVB_E are used for the first and second gate drivers 401 and 402 to generate gate signals. The method of generating the first clock signal CKV_O, the first clock bar signal CKVB_O, the second clock signal CKV_E and the second clock bar signal CKVB_E using the first CPV signal CPV_O, the second CPV signal CPV_E, the first OE signal OE_O and the second OE signal OE_E will be described below in greater detail with reference to FIGS. 6 and 7.

The first gate driver 401 is enabled by the first scan start signal STVP_O and uses the first clock signal CKV_O and the first clock bar signal CKVB_O to sequentially output gate signals to odd-numbered gate lines, e.g., first and third gate lines G₁ and G₃. The second gate driver 402 is enabled by the second scan start signal STVP_E and sequentially outputs gate signals to even-numbered gate lines, e.g., second and fourth gate lines G₂ and G₄.

Accordingly, as shown in FIG. 4, all the gate lines G₁-Gₙ can be sequentially activated during every frame.

The first clock signal CKV_O is at a high level during a first high-level period P1 and at a low level during a first low-level period P3. The first clock signal CKV_O may make a high-to-low transition or a low-to-high transition within a first charge-sharing period P2. The second clock signal CKV_E is at a high level during a second high-level period P4 and at a low level during a second low-level period P6. The second clock signal CKV_E may make a high-to-low transition or a low-to-high transition within a second charge-sharing period P5.

Assuming that the time period of the first high-level period P1 or the second high-level period P4 is equal to a unit period of time referred to herein as 1H, the first clock signal CKV_O may be at a low level during the second charge-sharing period P5 and at a high level during a charge-sharing period immediately preceding the second high-level period P4 and corresponding to the first high-level period P1. In other words, the phase difference between the first clock signal CKV_O and the second clock signal CKV_E is a delay equal to 1H. In this case, the time period during which a high-level voltage is applied to each gate line may be 1H, and time periods during which a high-level voltage is applied to the gate lines G₁-G₄ do not overlap each other. In other words, the first charge-sharing period P2 and the first high-level period P1 of the second clock signal CKV_E may overlap each other. Similarly, the second charge-sharing period P5 and the first low-level period P3 of the first clock signal CKV_O may overlap each other. However, the invention is not limited to the case where the phase difference between the first clock signal CKV_O and the second clock signal CKV_E is 1H.

Thus, the first charge-sharing period P2 of the first clock signal CKV_O and the second high-level period P4 of the second clock signal CKV_E may overlap each other; or the first charge-sharing period P2 of the first clock signal CKV_O and the second low-level period P6 of the second clock signal CKV_E may overlap each other. Similarly, the second charge-sharing period P5 of the second clock signal CKV_E and the first high-level period P1 of the first clock signal CKV_O may overlap each other; or the second charge-sharing period P5 of the second clock signal CKV_E and the first low-level period P3 of the first clock signal CKV_O may overlap each other. However, the invention is not limited to cases where the phase difference between the first clock signal CKV_O and the second clock signal CKV_E is 1H. In the case where a phase difference between the first clock signal CKV_O and the second clock signal CKV_E is smaller than 1H, time periods during which high-level voltages are applied to the respective gate lines G₁-G₄ may overlap each other.

Next, the operations in an interlaced mode of various modules of the timing controller 500 in FIG. 1 will be described in more detail with reference to FIGS. 1, 3, 5A and 5B.

In the interlaced mode, during the time period of one frame, the timing controller 500 outputs either the first scan start signal STV_O or the second scan start signal STV_E, either the first CPV signal CPV_O or the second CPV signal CPV_E, and either the first OE signal OE_O or the second OE signal OE_E. For example, when the mode selector 510 receives the display mode information INFO from an external circuit the mode selector 510 outputs the mode signal MODE for selecting the interlaced mode, the control signal generator 520 generates the first scan start signal STV_O, the first CPV signal CPV_O and the first OE signal OE_O in odd-numbered frames, and generates the second scan start signal STV_E, the second CPV signal CPV_E and the second OE signal OE_E in even-numbered frames.

In the interlaced mode, the clock generator 600 generates the first clock signal CKV_O and the first clock bar signal CKVB_O using the first CPV signal CPV_O and the first OE signal OE_O in odd-numbered frames and then supplies the first gate driver 401 with the generated signals (first clock signal CKV_O and the first clock bar signal CKVB_O), while generating the second clock signal CKV_E and the second clock bar signal CKVB_E using the second CPV signal CPV_E and the second OE signal OE_E in even-numbered frames and then supplies the second gate driver 402 with the generated signals (the second clock signal CKV_E and the second clock bar signal CKVB_E).

Thus, as shown in FIG. 5A, in odd-numbered frames, the first gate driver 401 is enabled by the first scan start signal STVP_O to sequentially supply with gate signals to the odd-numbered gate lines, e.g., first and third gate lines G₁ and G₃. At this time, the even-numbered gate lines, e.g., second and fourth gate lines G₂ and G₄, are maintained at a low level.

As shown in FIG. 5B, in even-numbered frames, the second gate driver 402 is enabled by the second scan start signal STVP_E to sequentially supply gate signals to even-numbered gate lines, e.g., second and fourth gate lines G₂ and G₄. At this time, the odd-numbered gate lines, e.g., the first and third gate lines G₁ and G₃, are maintained at a low level.

To summarize, in the progressive mode, the first and second gate drivers 401 and 402 are both enabled to supply all the odd and even gate lines G₁-Gₙ with gate signals, while in the interlaced mode, only one of the first and second gate drivers 401 and 402 is enabled at a time to supply odd-numbered gate lines G₁-G₂ₙ₋₁ or even-numbered gate lines G₂-G₂n with gate signals. Since all of the gate lines G₁-Gₙ are supplied with gate signals in the progressive mode, power consumption may increase but display quality is enhanced. In the interlaced mode, only the odd or the even gate lines are supplied with gate signals, so that display quality may be lower while reducing power consumption. Therefore, the LCD 10 according to an exemplary embodiment of the present invention can alternately operate in a progressive mode or in an interlaced mode according to the driving condition or user requirements, thereby enhancing display quality while reducing power consumption.

The clock generator 600 shown in FIG. 1 will now be described in greater detail with reference to FIGS. 6 and 7.

FIG. 6 is a block diagram of the clock generator 600 shown in FIG. 1, and FIG. 7 is a signal diagram for explaining the operation of the clock generator 600 shown in FIG. 6.

In the following description, the case where the clock generator 600 receives a first CPV signal CPV_O and a first OE signal OE_O and generates a first clock signal CKV_O and a first clock bar signal CKVB_O is an example.

The clock generator 600 includes a logical OR-gate OR, a D-flipflop 610, a first clock-voltage-applying unit 620, a second clock-voltage-applying unit 630, a charge-sharing unit 640, and capacitors C1 and C2. However, the internal circuitry of the clock generator 601 is not limited to the illustrated example.

The D-flipflop 610 outputs a first clock enable signal ECS_O through a first output terminal Q while outputting an inverted first clock enable signal (second clock enable signal) OCS_O through a second output terminal /Q. In more detail, the first OE signal OE_O is input to the D-flipflop 610 through a clock terminal CLK, and the second output terminal /Q of the D-flipflop 610 is fed back and connected to an input terminal D thereof to output the first clock enable signal ECS_O toggled at every rising edge of the first OE signal OE_O. The first clock enable signal ECS_O is output (toggled) through the first output terminal Q while the second clock enable signal OCS_O having a phase opposite to that of the first clock enable signal ECS_O is output through the second output terminal /Q. Alternatively, when the first OE signal OE_O is not used in generating the first clock signal CKV_O and the first clock bar signal CKVB_O, the first CPV signal CPV_O, instead of the first OE signal OE_O, may be input to the D-flipflop 610 through the clock terminal CLK.

The first clock enable signal ECS_O is supplied to the first clock-voltage-applying unit 620 while the second clock enable signal OCS_O is supplied to the second clock-voltage-applying unit 630.

The logical OR-gate OR receives the first OE signal OE_O and the first CPV signal CPV_O and generates a charge charging control signal CPVX_O, which is then supplied to the charge-sharing unit 640. Alternatively, when the first OE signal OE_O is not used in generating the first clock signal CKV_O and the first clock bar signal CKVB_O, the logical OR-gate OR may be omitted and the first CPV signal CPV_O may serve as the charge charging control signal CPVX_O.

During the first high-level period P1, the first clock signal CKV_O is at a high level and the first clock bar signal CKVB_O is at a low level. During the first low-level period P3, the first clock signal CKV_O is at a low level and the first clock bar signal CKVB_O is at a high level. During the charge-sharing period P2, the first clock signal CKV_O makes a high-to-low transition and the first clock bar signal CKVB_O makes a low-to-high transition.

The first clock-voltage-applying unit 620 may comprise a first level-sifting buffer. The first clock-voltage-applying unit 620 is enabled by and responsive to the first clock enable signal ECS_O, and outputs a high-level voltage Von when the first clock enable signal ECS_O is in a high level, thereby charging the first capacitor C1 to the high-level voltage Von (P1 of FIG. 7). In addition, when the first clock enable signal ECS_O is at a low level, the first clock-voltage-applying unit 620 outputs a low-level voltage Voff, thereby charging the first capacitor C1 to the low-level voltage Voff (P3 of FIG. 7). Likewise, the second clock-voltage-applying unit 630 may comprise a second level-sifting buffer. The second clock-voltage-applying unit 630 is enabled by and responsive to the second clock enable signal OCS_O, and outputs a low-level voltage Voff when the second clock enable signal OCS_O is in a high level, thereby charging the second capacitor C2 to the low-level voltage Voff (P1 of FIG. 7). In addition, when the second clock enable signal OCS_O is at a high level, the second clock-voltage-applying unit 630 outputs a high-level voltage Von, thereby charging the second capacitor C2 to the high-level voltage Von (P3 of FIG. 7).

Here, the charge-sharing unit 640 receives the charge charging control signal CPVX_O, and makes the first capacitor C1 and the second capacitor C2 share charge during charge and discharge periods.

In more detail, when the charge charging control signal CPVX_O is deactivated to a low level, the first capacitor C1 and the second capacitor C2 are electrically connected to each other. Thus, the first capacitor C1 charged to the high-level voltage Von starts to be discharged and the second capacitor C2 receives charges from the first capacitor C1 to then starts to be charged to the high-level voltage Von. Thus, the first capacitor C1 and the second capacitor C2 share (begin to equalize) their stored charges during the charge-sharing period P2. The voltage CKV_O stored in the first capacitor C1 after the first capacitor C1 and the second capacitor C2 are electrically connected to each other during the charge-sharing period P2 is close to the low-level voltage Voff but is not equal to the low-level voltage Voff. The voltage CKVB_O stored in the second capacitor C2 after the first capacitor C1 and the second capacitor C2 are electrically connected to each other during the charge-sharing period P2 is close to the low-level voltage Von but is not equal to the low-level voltage Von. Accordingly, in the first low-level period P3, the first capacitor C1 can easily make a transition to the low-level voltage Voff, and the second capacitor C2 can easily make a transition to the high-level voltage Von.

The second clock signal CKV_E and the second clock bar signal CKVB_E are also generated through the same process as described above and thus a detailed description thereof has been be omitted. In alternative embodiments, the clock generator 600 may not include the charge-sharing unit 640.

The first and second gate drivers 401 and 402 shown in FIG. 1 are described below in greater detail with reference to FIGS. 8 and 9.

FIG. 8 is a block diagram of the first gate driver 401 shown in FIG. 1, and FIG. 9 is a circuit diagram of stages in the first gate driver 401 shown in FIG. 8.

The first gate driver 401 includes a plurality of cascade-connected stages ST₁ through ST₂ₙ. The odd stages ST₁-ST₂ⱼ₊₁ are connected to odd-numbered gate lines G₁-G₂ₙ₋₁ in one to one correspondence (e.g., j=n−1) via odd output gate signals Gout₁˜Gout₍₂ⱼ₊₁₎, respectively. The gate-off voltage Voff, the first clock signal CKV_O, the first clock bar signal CKVB_O, and an initialization signal INT_O are input in parallel to each of the respective stages ST₁-ST₂ₙ. The initialization signal INT_O may be supplied from the clock generator 600.

Each of the stages ST₁-ST₂ₙ may have a first clock terminal CK1, a second clock terminal CK2, a set terminal S, a reset terminal R, a power supply terminal GV, a frame reset terminal FR, a gate output terminal OUT1, and a carry output terminal OUT2.

For example, the carry signal Cout₍₂ⱼ₋₃₎ of the previous stage ST₂ⱼ₋₃ is input to the set terminal S of a stage ST₂ⱼ₋₁ connected to a (2j−1)th gate line; and a gate signal Gout₍₂ⱼ₊₁₎ of a next stage ST₂ⱼ₊₁ is input to the reset terminal R of the stage ST₂ⱼ₋₁. The first clock signal CKV_O and the first clock bar signal CKVB_O are input to the first clock terminal CK1 and the second clock terminal CK2, respectively, and the gate-off voltage Voff is input to the power supply terminal GV. The initialization signal INT_O or the carry signal Cout₍₂ₙ₎ of the last stage ST₂ₙ is input to the frame reset terminal FR. The gate output terminal OUT1 outputs a gate signal Gout₍₂ⱼ₋₁₎, and the carry signal output terminal OUT2 outputs a carry signal Cout₍₂ⱼ₋₁₎.

However, the first scan start signal STVP_O, instead of the carry signal of the previous stage, is input to the first stage ST₁, and the first scan start signal STVP_O, instead of the gate signal output from the next stage, is input to the last stage ST₂ₙ.

The exemplary stage ST₂ⱼ₋₁ shown in FIG. 8 is described below in greater detail with reference to FIG. 9.

Referring to FIG. 9, the stage ST₂ⱼ₋₁ includes a buffer unit 410, a charging unit 420, a pull-up unit 430, a carry signal generator 470, a pull-down unit 440, a discharging unit 450 and a holding unit 460.

The buffer unit 410 includes a transistor T4 having its drain and its gate connected to each other, and supplies the carry signal Cout₍₂ⱼ₋₃₎ of the previous stage ST₂ⱼ₋₃ charging unit 420 to the carry signal generator 470 and to the pull-up unit 430 Here, the carry signal Cout₍₂ⱼ₋₃) of the previous stage ST₂ⱼ₋₃ has been input through the set terminal S of the stage ST₂ⱼ₋₁.

The charging unit 420 includes a capacitor C3 having a first terminal connected to the source of transistor T4 in the buffer unit 410, to the pull-up unit 430 and to the discharging unit 450 and a second terminal connected to a gate output terminal OUT1. The charging unit 420 is supplied with and charged by the carry signal Cout₍₂ⱼ₋₃₎ of the previous stage ST₂ⱼ₋₃.

The pull-up unit 430 includes a transistor T1 having its drain connected to the first clock terminal CK1, its gate connected to a first terminal of capacitor C3 in charging unit 420, and its source connected to the second terminal of capacitor C3 and to the gate output terminal OUT1. While the capacitor C3 of the charging unit 420 is charged, the transistor T1 is turned ON, so that the first clock signal CKV_O applied through the first clock terminal CK1 is supplied as the gate signal Gout₍₂ⱼ₋₁₎ through the gate output terminal OUT1.

The carry signal generator 470 includes a transistor T15 having a drain connected to the first clock terminal CK1, a source connected to the gate output terminal OUT1, and a gate connected to the buffer unit 410, and a capacitor C4 connected to the gate and the source. The capacitor C2 is supplied with the carry signal Cout₍₂ⱼ₋₃₎ of the previous stage ST₂ⱼ₋₃, and is charged. If the capacitor C4 is charged, the transistor T15 is turned ON, so that the first clock signal CKV_O is output as the carry signal Cout₍₂ⱼ_{_{—}}₁₎ through a carry output terminal OUT2.

The pull-down unit 440 includes a transistor T2 having its drain connected to the source of transistor T1 and to the second terminal of the capacitor C1, its source connected to the power supply terminal GV, and its gate connected to the reset terminal R. The pull-down unit 440 is turned ON by a gate signal Gout₍₂ⱼ₊₁₎ of a next stage ST₂ⱼ₊₁ applied through the reset terminal R, and pulls down the gate signal Gout₍₂ⱼ₋₁₎ to a gate-off voltage Voff.

The discharging unit 450 includes a transistor T9 having its gate connected to the reset terminal R, its drain connected to the first terminal of the capacitor C3, its source connected to the power supply terminal GV to discharge the charging unit 420 in response to the gate signal Gout₍₂ⱼ₊₁₎ of the next stage ST₂ⱼ₊₁. The discharging unit 450 further includes a transistor T6 having its gate connected to the frame reset terminal FR, its drain connected to the first terminal of the capacitor C3, and its source connected to the power supply terminal GV to discharge the charging unit 420 in response to the initialization signal INT_O. Thus, the discharging unit 450 discharges the capacitor C3 to the gate-off voltage Voff in response to the gate signal Gout₍₂ⱼ₊₁₎ of the next stage ST₂ⱼ₊₁ or in response to the initialization signal INT_O to turn OFF the pull-up unit 430.

The holding unit 460 maintains a high-level state when the gate signal Gout₍₂ⱼ_{_{—}}₁₎ makes a low-to-high transition, and after the gate signal Gout₍₂ⱼ_{_{—}}₁₎ makes a high-to-low transition, and maintains the gate signal Gout₍₂ⱼ_{_{—}}₁₎ at a low level during the time period of one frame, irrespective of voltage levels of the first clock signal CKV_O and the first clock bar signal CKVB_O.

First, in a case where the gate signal Gout₍₂ⱼ_{_{—}}₁₎ makes a low-to-high transition, transistors T8 and T13 are turned ON. The transistor T13 being ON turns OFF transistor T7 to prevent the first clock signal CKV_O of a high level from being supplied to transistor T3, while transistor T8 being ON turns OFF transistor T3. Therefore, the gate signal Gout₍₂ⱼ_{_{—}}₁₎ is maintained at the high-level.

Next, after the gate signal Gout₍₂ⱼ_{_{—}}₁₎ makes a high-to-low transition, the transistors T8 and T13 are turned OFF. If the first clock signal CKV_O is in a high level, transistors T7 and T12 being ON turn ON transistor T3 to maintain the gate signal Gout₍₂ⱼ_{_{—}}₁₎ at a low level. In addition, transistor T10 is turned ON to make the gate of transistor T1 maintain a low-level state, so that the high-level first clock signal CKV_O is not output to the gate output terminal OUT1. Therefore, the first clock bar signal CKVB_O is in a high level and transistors T5 and T11 are turned ON. The turned-ON transistor T5 maintains the gate signal Gout₍₂ⱼ_{_{—}}₁₎ at a low level, while the turned-ON transistor T11 maintains the first terminal of the capacitor C3 at a low level. Therefore, the gate signal Gout₍₂ⱼ_{_{—}}₁₎ is maintained at a low level during the time period of one frame.

Alternatively, the stage ST₂ⱼ₋₁ may not include the carry signal generator 470. In such a case, the stage ST₂ⱼ₋₁ may receive the gate signal Gout₍₂ⱼ₋₃), instead of the carry signal Cout₍₂ⱼ₋₃), of the previous stage ST₂ⱼ₋₃ through the set terminal S for operation.

The second gate driver 402 includes a plurality of cascade-connected stages ST₂-ST₂ₙ, each connected to even-numbered gate lines G₂-G₂ₙ in one to one correspondence, similarly as in the case of first gate driver 401 shown in FIG. 8. The internal circuit of each stage of the second gate driver 402 is also shown in FIG. 9. For explanatory convenience, a detailed description of the second gate driver 402 has been omitted here.

As described above, an LCD including a timing controller and a driving method according to an exemplary embodiment of the present invention, can alternately operate in a progressive mode or an interlaced mode. Accordingly, the present invention enables reduction of power consumption and enhancement of display quality.

While the present invention has been particularly shown and described with reference to exemplary embodiments thereof, it will be understood by those of ordinary skill in the art that various changes may be made in the form and details without departing from the spirit and scope of the present invention as defined by the following claims. It is therefore desired that the present embodiments be considered in all respects as illustrative and not restrictive, reference being made to the appended claims rather than the foregoing description to define the scope of the invention.

What is claimed is:

1. A liquid crystal display (LCD) comprising:
a signal-supply unit configured to receive display mode information and to supply a first scan start signal and a second scan start signal within the time period of one frame while in a progressive mode, and configured to supply a selected one of the first scan start signal or the second scan start signal while in an interlaced mode, the first and second scan start signals having different phases;
a liquid crystal display (LCD) panel including a first plurality of gate lines, second plurality of gate lines, a plurality of data lines, and a plurality of pixels, each pixel coupled to one of the gate lines and to one of the data lines;
a first gate driver configured to sequentially output first gate signals to the first plurality of gate lines in response to the first scan start signal; and
a second gate driver configured to sequentially output second gate signals to the second plurality of gate lines in response to the second scan start signal.

2. The LCD of claim 1, wherein each of the first gate driver and the second gate driver includes a plurality of cascade-connected stages, each stage formed on the LCD panel and configured to output one of the gate signals.

3. The LCD of claim 1, wherein the first gate driver and second gate driver are both enabled during each frame while in the progressive mode, and only one of the first and second gate drivers is enabled during each frame while in the interlaced mode.

4. The LCD of claim 1, wherein one horizontal period, called “1H”, corresponds to the time during which the first gate signal is applied at a high level to one of gate lines, and the phase difference between the first and second scan start signals is equal to 1H.

5. The LCD of claim 1, wherein the signal-supply unit is further configured to selectively supply
a first clock signal, an inverted first clock signal having an opposite phase to that of the first clock signal,
a second clock signal, and an inverted second clock signal having an opposite phase to that of the second clock signal,
the first clock signal and the second clock signal having different phases.

6. The LCD of claim 5, wherein the signal-supply unit:
supplies all of the first clock signal, the inverted first clock signal, the second clock signal, and the inverted second clock signal during the time period of one frame while in the progressive mode; and
while in the interlaced mode, supplies only the first clock signal and the inverted first clock signal during the time period of one frame and then supplies only the second clock signal and the inverted second clock signal during the time period of the next one frame.

7. The LCD of claim 5, wherein the first clock signal is at a high level during a first high-level period and is at a low level during a first low-level period, and makes a high-to-low transition or a low-to-high transition during a first charge-sharing period; and the second clock signal is at a high level during a second high-level period and is at a low level during a second low-level period, and makes a high-to-low transition or a low-to-high transition during a second charge-sharing period.

8. The LCD of claim 7, wherein while in the progressive mode, the first charge-sharing period and the second high-level period overlap each other and the second charge-sharing period and the first low-level period overlap each other.

9. The LCD of claim 5, wherein each of the first and second gate drivers includes a plurality of cascade-connected stages, each stage configured to output a predetermined one of a received clock signal and a received inverted clock signal as one of the gate signals in response to a scan start signal or the carry signal of the previous stage.

10. The LCD of claim 2, wherein while in the interlaced mode the signal-supply unit supplies the first gate driver with the first scan start signal during the time period of one frame and then, supplies the second gate driver with the second scan start signal during the time period of the next one frame.

11. A liquid crystal display (LCD) comprising:
a timing controller configured to receive display mode information, and to supply a first scan start signal and a second scan start signal within the time period of one frame while in a progressive mode, and configured to supply while in an interlaced mode one of either
the first scan start signal and the first clock generation control signal, or
the second scan start signal and the second clock generation control signal,
the first and second scan start signals having different phases and the first and second clock generation control signals having different phases;
a clock generator configured to generate a first clock signal and an inverted first clock signal having a phase opposite to that of the first clock signal using the first clock generation control signal, and to generate a second clock signal and an inverted second clock signal having a phases opposite to that of the second clock signal using the second clock generation control signal while in the progressive mode, and configured to generate while in the interlaced mode either
the first clock signal and the inverted first clock signal, or
the second clock signal and the inverted second clock signal,
the first clock signal and the second clock signal having different phases;
a liquid crystal display (LCD) panel including a first plurality of gate lines, a second plurality of gate lines, a plurality of data lines, and a plurality of pixels, each pixel coupled to one of the gate lines and to one of the data lines;
a first gate driver configured to sequentially output first gate signals to the first plurality of gate lines in response to the first scan start signal; and
a second gate driver configured to sequentially output second gate signals to the second plurality of gate lines in response to the second scan start signal.

12. The LCD of claim 11, wherein one horizontal period, called “1H”, corresponds to the time in which the first gate signal is applied at a high level to one of the gate lines in the first plurality of gate lines, and the phase difference between the first and second scan start signals is equal to 1 H.

13. The LCD of claim 12, wherein one horizontal period, called “1H”, corresponds to the time in which the first gate signal is applied at a high level to one of the gate lines in the first plurality of gate lines, and the phase difference between the first and second clock generation control signals is equal to 1H.

14. The LCD of claim 12, wherein the first clock signal is at a high level during a first high-level period and is at a low level during a first low-level period, and makes a transition between the high level and the low level during a first charge-sharing period; and the second clock signal is in a high level during a second high-level period and is at a low level during a second low-level period, and makes a transition between the high level and the low level during a second charge-sharing period.

15. The LCD of claim 11, wherein while in the progressive mode, the first charge-sharing period and the second high-level period overlap each other and the second charge-sharing period and the first low-level period of the first clock signal overlap each other.

16. The LCD of claim 11, wherein each of the first and second gate drivers includes a plurality of cascade-connected stages, each state configured to output a gate signal and a carry signal, and wherein each stage has at least one amorphous silicone thin film transistor (a-Si TFT) formed on the LCD panel.

17. A display apparatus comprising:
a display panel including first plurality of gate lines, a second plurality of gate lines, a plurality of data lines, and a plurality of pixels, each pixel coupled to one of the gate lines and to one of the data lines;
a first gate driver connected to the first plurality of gate lines and configured to sequentially output gate signals to the gate lines of the first plurality of gate lines in response to a first scan start signal; and
a second gate driver connected to the second plurality of gate lines and configured to sequentially output gate signals to the gate lines of the second plurality of gate lines in response to a second scan start signal,
wherein the first scan start signal and the second scan start signal are applied to both the first gate driver and the second driver respectively while the display apparatus displays video images and wherein only one of the first scan start signal and the second scan signal is applied while the display apparatus displays a still image.

18. The display apparatus of claim 17, wherein each of the first gate driver and the second gate driver includes a plurality of cascade-connected stages, each stage configured to be formed on the display panel.

19. The display apparatus of claim 18, wherein the first scan start signal and the second start signal have different phases.

20. A display apparatus comprising:
a display panel including a plurality of gate lines, a plurality of data lines, and a plurality of pixels coupled to the gate lines and data lines, the a plurality of gate lines divided into a plurality of gate line groups; and
a plurality of gate drivers respectively connected to the plurality of gate line groups and to output gate signals,
wherein all of the plurality of gate drivers are configured to output their gate signals while the display apparatus displays moving images, and wherein only one of the plurality of gate drivers outputs its gate signals while the display apparatus displays still images.

21. The display apparatus of claim 20, wherein the plurality of gate line groups comprise a first gate line group and a second gate line group, and wherein the plurality of gate drivers comprise a first gate driver and a second gate driver,
wherein each of the first and second gate drivers includes a plurality of cascade-connected stages, each stage formed on the display panel.

22. A method of driving a liquid crystal display (LCD), the method comprising:
receiving display mode information, and selecting one of a progressive mode and an interlaced mode based on the received display mode information;
supplying a first scan start signal to a first gate driver and supplying a second scan start signal within the time period of one frame while in the progressive mode; and
while in the interlaced mode, supplying the first scan start signal to the first gate driver within the time period of one frame, and then supplying the second scan start signal to a second gate driver within the time period of the next frame,
wherein the first gate driver is configured to sequentially output first gate signals to a first plurality of gate lines in response to the first scan start signal, and the second gate driver is configured to sequentially output second gate signals to a second plurality of gate lines in response to the second scan start signal.

23. The method of claim 22, further comprising:
sequentially supplying gate signals to the first plurality of gate lines and the second plurality of gate lines during the time period of one frame in response to the first and second scan start signals while in the progressive mode, and
while in the interlaced mode, sequentially supplying gate signals to the first plurality of gate lines during the time period of one frame in response to the first scan start signal, and then sequentially supplying gate signals to the second plurality of gate lines during the time period of the next one frame in response to the second scan start signal.

24. The method of claim 22, wherein the first and second scan start signals have different phases.

25. The method of claim 22, wherein one horizontal period, called “1H”, corresponds to the time during which a gate signal of a high level is applied to a gate line, and the phase difference between the first and second scan start signals is equal to 1H.
